(19) United States
(12) Patent Application Publication
(10) Pub. No.: US 2014/0373697 A1
(43) Pub. Date: Dec. 25, 2014

(54) Apparatus for Recycling Tires by Cutting Into Sections

(71) Applicant: OTR Recycling Corp., Ashern (CA)

(72) Inventors: Peter Schroeder, Ashern (CA); Ronald Kornelsen, Arborg (CA)

(21) Appl. No.: 13/926,329

(22) Filed: Jun. 25, 2013

(51) Int. Cl. B26D 3/00

(52) U.S. Cl. CPC B26D 3/005
USPC 83/563

(57) ABSTRACT

A cutting tool assembly for a tire cutting apparatus features a tool holder and one or more cutting members removably installed on the tool holder to form at least one cutting feature thereon proximate a first end of the tool holder for cutting the tire by forcing of said first end of the tool holder toward the crown of the tire by an actuator during driven rotation of the tire. Each cutting member comprising a wear material of greater hardness than the tool holder. The softer, less brittle material of the tool holder withstands the stresses imposed on the assembly during cutting the steel and rubber composition of the tire, while the harder material of the replaceable cutting member provides better wear resistance at the cutting features.

### FIELD OF THE INVENTION

This invention relates to an apparatus for use in recycling tires by cutting the tires into sections, and more particularly to an apparatus configured to use a multi-piece cutting tool with one or more replaceable cutting members to the cut radially through the crown of the tire to split the same into annular sections.

### BACKGROUND OF THE INVENTION

Recycling large industrial, construction, mining equipment tires requires the tires be deconstructed to a manageable size to fit into downstream processing equipment. The tires in question can, for example, range in size from 13 to 4 feet in diameter, weighing up to 4 tons with up to 20 to 30 ply of rubber, steel and fabric.

Currently, there are three standard methods of deconstructing this class of tires. Track hoe mounded demolition shears, “punch” cutters and turntable cutters. The tool holder of the present invention is primarily, but not exclusively, intended is for turntable type GMT (Giant Mining Tire) cutters.

The wire component in these tires consists of high tensile steel with a Rockwell hardness ranging from 60 to 65. Rubber in these tires is very abrasive on its own but in combination with steel cutting through the face or sidewalls require specialized equipment.

To cut through this varied combination of materials, Applicant has developed a tool bit holder designed to stand up to the stress of the work without losing the carbide or other hard material that makes up the leading working or cutting edges of the assembled cutting unit. The tool holder in question is for turntable type tire cutters, where a cutting assembly is forced in a radial direction relative to the tire while the tire is rotated about its central axis, whereby the cutting tool or bit cuts through the crown of the tire.

Examples of tire cutters that use a turntable or other rotational support to drive rotation of a tire about its axis while cutting either radially through the crown of the tire around the circumference thereof are disclosed in U.S. Pat. Nos. 4,012,973, 4,134,316, 4,450,738, 5,054,351, 5,199,337, and 6,240,819, some of which use rotating cutting blades and others of which use non-rotating knife style cutters. Other references relating to cutting or compacting of tires or breaking down of tires into smaller pieces for recycling include U.S. Pat. Nos. 5,551,325 and 8,225,701 and International PCT Publication WO2007/097645. Another reference relating to tire processing methods involving cutting of tires during driven rotation thereof is U.S. Pat. No. 3,993,115, which discloses a tire truing machine.

The present application discloses a unique cutting tool assembly for a turntable tire cutter in which a tool holder or cutting bit holder carries one or more removable and replaceable cutting members composed of harder wear material than the holder itself.

### SUMMARY OF THE INVENTION

According to one aspect of the invention there is provided a tire cutting apparatus for cutting tires into sections, the apparatus comprising:

a rotational support device arranged to receive and carry a tire in a mounted position carried on the rotational support device, and to effect driven rotation of the tire in the mounted position about a rotational axis passing centrally through a central opening of the tire around which the tire circumferentially closes;

a cutting tool assembly comprising:
a tool holder movably supported at a location radially spaced from a circular path around the rotational axis at which the crown of the tire resides in the mounted position, the tool holder having a first end disposed radially nearer the circular path than an opposing second end; and
one or more cutting members removably installed on the tool holder to each form a respective cutting feature thereon proximate the first end of the tool holder, each of said one or more cutting members comprising a wear material of greater hardness than the tool holder;

and an actuator operable to force the tool holder from a non-cutting state, in which the cutting tool assembly does not reach the circular path, into a cutting state in which the cutting tool assembly reaches said circular path so as to cut into the crown of the tire.

Preferably the one or more cutting members comprise a tip member and the tool holder is arranged for removable mounting of the tip member at the first end of the tool holder in a cutting position projecting from the first end of the tool holder with a point of the tip member pointing away from the tool holder.

Preferably the tip member is double pointed, having a pair of opposing points situated at opposing ends of the tip member and pointing in opposite directions therefrom.

Preferably the tool holder comprises a hollow mounting socket extending into the tool holder from the first end thereof for installation of the tip member into the cutting position by insertion of the tip member into a position partially seated within the mounting socket.

Preferably the tool holder comprises a blocking member spanning across the mounting socket at a distance from an inner end thereof to block abutment of either point of the tip member with the inner end of the mounting socket under insertion of said point of the tip member into the mounting socket.

Preferably the blocking member comprises a roll pin inserted into a transverse bore of the through body that passes through the mounting socket.

Preferably the one or more cutting members comprise an edge member arranged to fit over an edge of the tool body that faces opposite a direction of the tire's rotation so as to provide said edge of the tool body with a cutting edge that splits the crown of the tire apart around the circumference thereof as the tire rotates past the tool body after initial piercing of the tip member into the crown of the tire.

Preferably the edge member is also arranged to secure the tip member in place in the cutting position.

Preferably the edge member fits over an open side of the socket at the edge of the tool body that faces opposite the direction in which the tire is rotated by the rotational support device.

Preferably the tip member, the socket and the edge member are cooperably sized and shaped so as to place the edge member in clamping abutment with the tip member to secure the tip member in place in the socket.

Preferably the socket and the tip member are cooperably sized and shaped to place a surface the tip member flush with the open side of the socket, and the edge member clamps against said surface of the tip member at said open side of the socket to clamp the tip member against an opposing closed side of the socket.

Preferably there is provided a fastener bore passing through the tool body from the edge of the tool body that receives the edge member to an opposing edge of the tool body to enable fastening of the edge member to the tool body via said fastener bore.

Preferably a sharpened portion of the edge of the tool body at which the edge member is received is left uncovered by said edge member adjacent an end of said edge member opposite the first end of the tool body.

Preferably the edge member is arranged to reach fully to the first end of the tool body, and comprises a sloped edge that slopes obliquely from the cutting edge to the first end of the tool body.

Preferably the tool body comprises an elongated plate-shaped member, the first and second ends of the tool body are spaced apart along a length dimension of said plate-shaped member and a width dimension of the plate-shaped member lies in a plane perpendicular to the rotational axis.

Preferably the plate-shaped member comprises metal plate.

Preferably the wear material of at least one of the one or more cutting members comprises tungsten carbide.

The location at which the tool holder is movably supported is preferably disposed radially outward from the circular path such that the cutting tool assembly resides radially outward of the circular path in the non-cutting state and each cutting feature reaches the circular path under driving of the cutting assembly inwardly through the circular path by the actuator.

According to another aspect of the invention there is provided a cutting tool assembly for a tire cutting apparatus having a rotational support device arranged to support and rotate a tire about a rotational axis passing centrally through a central opening of the tire and an actuator operable to force the cutting tool into the crown of the tire so as to cut into and through the crown around the circumference of the tire during driven rotation of the tire by the rotational support device, the cutting tool comprising:

a tool holder; and

one or more cutting members removably installed on the tool holder to form at least one cutting feature thereon proximate a first end of the tool holder for cutting the tire by forcing of said first end of the tool holder toward the crown of the tire, each cutting member comprising a wear material of greater hardness than the tool holder.

### BRIEF DESCRIPTION OF THE DRAWINGS

One embodiment of the invention will now be described in conjunction with the accompanying drawings in which:

FIG. 1 is a schematic overhead plan view, not to scale, of a tire cutting apparatus employing a cutting tool assembly of the present invention to cut a tire into annular sections by forcing the cutting tool radially into the crown of the tire during rotation of the tire in order to cut radially through and circumferentially around the tire in order to divide the same into annular sections.

FIGS. 2A, 2B and 2C are perspective, edge-on and side views, respectively, of the cutting tool assembly of FIG. 1, which features replaceable cutting tip and cutting edge members of hard wear material removably carried on a tool holder.

FIGS. 3A, 3B, 3C and 3D are perspective, edge-on, side and end views, respectively, of the tool holder of the cutting tool assembly of FIG. 2.

FIGS. 4A, 4B, 4C, 4D are perspective, edge-on, side and end views, respectively, of the cutting edge member of the cutting tool assembly of FIG. 2.

FIG. 4E is another view of the cutting edge member from a viewpoint opposing that of the edge-on view of FIG. 4B.

FIGS. 5A, 5B and 5C are perspective, edge-on and side views, respectively, of the cutting tip member of the cutting tool assembly of FIG. 2, as provided by a commercially available carbide threading insert.

In the drawings like characters of reference indicate corresponding parts in the different figures.

### DETAILED DESCRIPTION

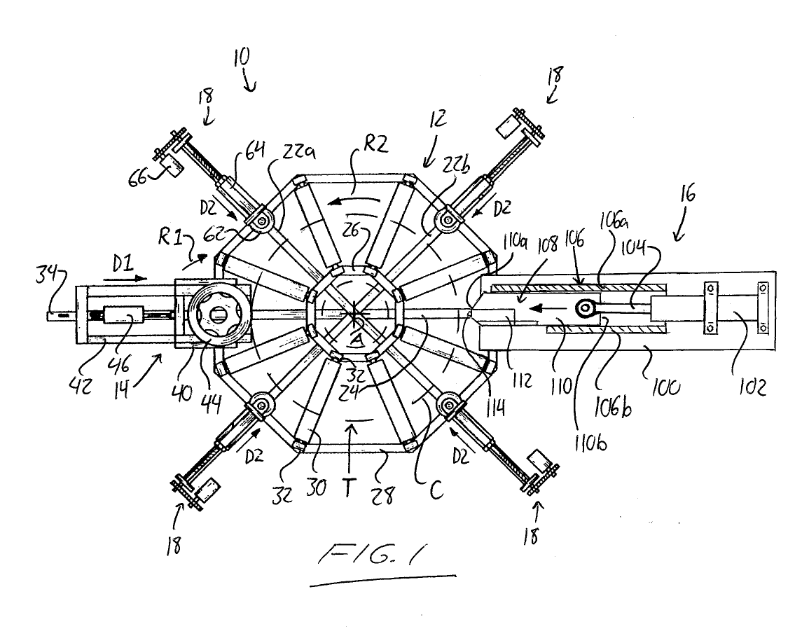

FIG. 1 schematically shows an embodiment of a tire cutting apparatus 10 employing a cutting tool assembly of the present invention in order to cut radially through and circumferentially around the crown of a tire during driven rotation of the tire by a turntable assembly. Solely for the purpose of illustrating the general context in which an inventive cutting assembly 16 of the present invention may be used, and to present an example of how various prior art cutting machines may be adapted to use the cutting assembly of the present invention, the drawings of the apparatus show a turntable configuration employing the cutter table structure 12 and drive assembly 14 disclosed in aforementioned U.S. Pat. No. 5,199,337. However, it will be appreciated from the following description that a cutting tool assembly of the present invention may be used with any of a variety of different mechanisms capable of supporting a tire and rotating the tire around its central axis.

For example, prototype cutting assemblies of the present invention have been built and tested on a more conventional GMT or OTR turntable structure, in which a flat, circular table-top is mounted atop a rotatable pedestal and features suitable means for securing a tire in a centered position on the table top. The pedestal is driven for rotation about a vertical axis passing centrally through the table top, and centrally through the opening of the tire mounted thereon, by a hydraulic motor via a chain that is entrained about a vertical output shaft of the hydraulic motor and a circumferential gear on the pedestal. Accordingly, the tire is rotated concentrically about the central vertical axis of the turntable under operation of the motor. The prototype cutting assembly is mounted radially outward of the rotating tabletop in the same positional and movable relation to the rotating tire as is described below in the context of the illustrated prior art turntable design.

Briefly summarizing the illustrated prior art cutting table and drive assembly before turning to the details of the unique cutting assembly of the present invention, the cutting table includes a sub-frame constructed of a guide assembly support member fabricated from two perpendicular beams 22a, 22b lying horizontally overtop a horizontal drive and cutter assembly support beam 24. Central and outer octagon roller supports 26, 28 are disposed concentrically on a vertical axis A in a common horizontal disposed over the sub-frame with the sides of the octagons parallel with one another. Rotatably attached between the corners of the octagons are eight tire carrier rollers 30 supported between bearings 32 mounted on the octagons. The rollers 30 lie in a common horizontal plane over the sub-frame, which may be supported at an elevation above ground by suitable support legs.

Slidably mounted on a first end 34 of the central support beam 24 is a drive assembly 14, and a guide assembly 18 is slidably mounted on each end of the cross beams 22a, 22b. The illustrated drive assembly 14 a hydraulic motor mounted on a motor frame 40 which is adjustably mounted on a support frame 42. A drive wheel 44 is rotatably driven by the shaft of the motor. The drive assembly 14 may be linearly displaced in a horizontal direction D1 radial to the axis A, for example by a hydraulic cylinder 46, so as to accommodate tire casings of various diameters at a position residing atop the rollers 30 with the tire's central rotational axis coincident with the frame's central axis A. A tire placed in this manner is schematically shown at T using broken lines in FIG. 1.

Each guide assembly 18 includes a roller 62 attached to a frame 64 which is slidably driven by a hydraulic motor 66 operating a linear actuator in a horizontal direction D2 radial to the central axis A. Each roller 62 is supported for free rotation about a respective vertical axis. In this fashion, each of the assemblies 18 may be slidably driven along the length of their respective cross beams 22a, 22b such that tire casings of various diameters may be accommodated by the apparatus 10.

The drive assembly 14 and guide assemblies are used in the same manner as the prior art, whereby after placement of a tire T in a central position concentric with the frame axis A so as to close horizontally around the vertical axis A at a mounted position atop the horizontal table, the drive assembly wheel 44 and the idler rollers 62 of the guide assemblies are displaced radially inward toward the central axis A so as to each abut the crown C of the tire T, whereby driven rotation of the drive wheel 44 in direction R1 about the drive wheel's vertical axis causes rotation of the tire T in the opposing direction R2 about central axis A. The guide rollers 62 maintain the tire in its position centered on axis A during the tire rotation effected by drive wheel 44.

Attention is now turned to the cutting assembly 16, where the apparatus of FIG. 1 differs from the prior art. The present invention shows a knife-type cutting assembly in place of the rotary-blade cutting assembly of U.S. Pat. No. 5,199,337. A horizontal base 100 of the cutting assembly 16 is mounted atop the drive and cutter support beam 24 adjacent an end thereof opposite the drive assembly 14. A hydraulic cylinder 102 is fixed in place atop the base 100 to lie horizontally on a respective radius of the central axis A such that the piston rod 104 of the hydraulic cylinder is displaceable back and forth along this radius of the frame, just like the piston rod of the drive assembly's hydraulic cylinder 46. A cutting tool guide 106 features a pair of upstanding vertical walls 106a, 106b projecting up from the cutting assembly base 100 and lying parallel to the piston rod 104 on opposite sides thereof.

With continued reference to FIG. 1, a knife-style cutting tool 108 of the present invention features a tool holder body 110 formed of a metal plate, for example of ⅜-inch 1080 steel. A first end of the 110a of the tool holder points inwardly toward the central axis A, and is positioned to lie outside of the cutting tool guide 106 at a location between the cutting tool guide 106 and the central axis A.

An opposing second end 110b of the tool holder body 110 points radially outward, i.e. toward the hydraulic cylinder 102, and resides between the two walls 106a, 106b of the cutting tool guide 106. The second end of the tool holder body is slidable back and forth along the radially oriented channel bound between the side walls 106a, 106b of the guide 106 by extension and retraction of the piston rod 104 of the hydraulic cylinder 102, the distal end of which is fastened to the tool holder body 110 at a point between the tool guide walls 106a, 106b near the second end 110b of the tool holder body 110.

The plate shaped tool holder body 10 lies in a horizontal plane elevated above the plane of the tire support rollers 30 by a distance that doesn't exceed the width of the tire to be cut, whereby the tool holder body lies at an intermediate plane of the tire residing between the planes of the tire's side walls. The tool holder body 110 has an elongated shape whose longitudinal dimension lies parallel to the radius of the axis A along which the piston rod 104 is displaced. Between the two guide walls 106a, 106b, the plate shaped tool holder body 110 features parallel longitudinal edges that run respectively along these two guide walls 106a, 106b, which thus constrain the motion of the tool holder body 10 to a radial direction relative to the central axis A. Beyond the ends of the guide walls 106a , 106b nearest the central axis A, the tool holder body 110 carries a cutting edge member 112 that is removably attached to the tool holder body 110 on an edge thereof that faces opposite to the rotational direction R2 of the tire T. At the first end of the tool body 110, a cutting tip member 114 is removably attached to the tool holder body 110 in a position projecting from the first end thereof toward the central axis A.

The cutting tool 108 is initially located in a non-cutting state (shown in FIG. 1) corresponding to a retracted state of the hydraulic cylinder 102, whereby the cutting tool 108 resides entirely radially outward of the crown C of a tire T placed concentrically on the table. FIG. 1 shows the non-cutting state, in which the first end 110a of the tool 108 is situated radially outward of the broken line circle C that represents the outer face of the crown C or tread area of the schematically illustrated tire T. With the drive wheel 44 and guide rollers 62 abutted against the crown of the tire and the drive wheel 44 driven in order to rotate the tire T in direction R2, the piston rod 104 of the hydraulic cylinder 102 is extended in order to force the cutting tool 108 radially toward the central axis A, and thus toward the crown C of the tire T closing around the axis A. The pointed tip member 114 of the cutting tool 108 pierces into the crown of the tire, at which point continued exertion of force on the cutting tool 108 by the cylinder 102 continues to force the tip member 114 into the crown of the tire, while rotation of the tire T in direction R2 drives the crown of the tire against a cutting edge formed by edge member 112, thus splitting the crown of the tire apart as the tire is driven into the cutting edge and split apart above and below the cutting tool 108.

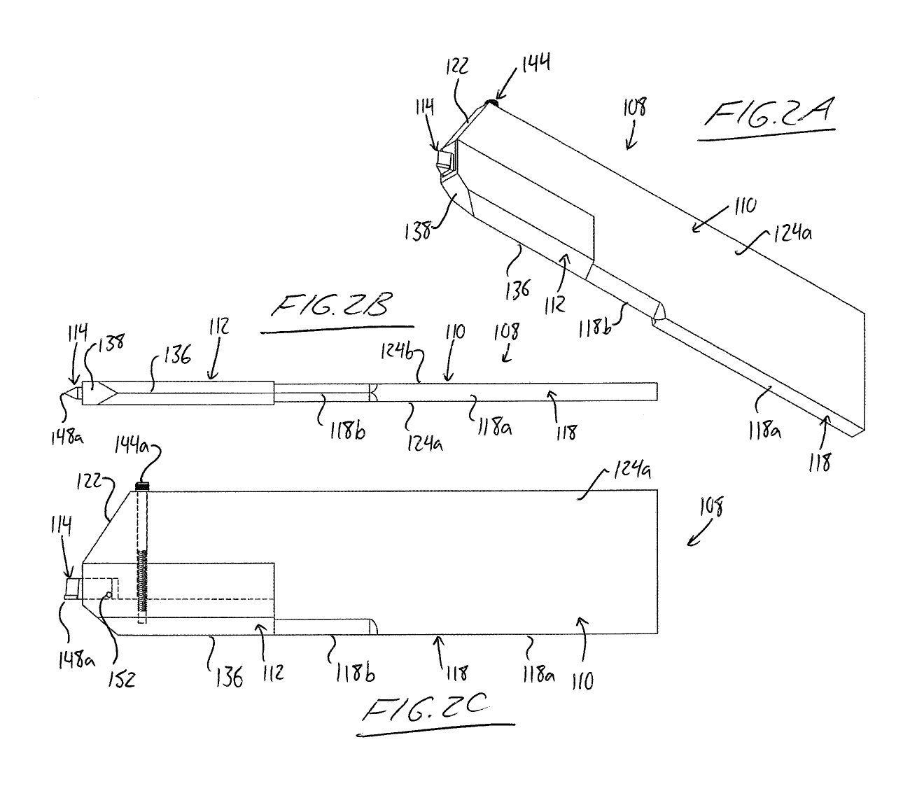

More detail of the unique cutting tool 108 of the present invention is now outlined as follows, with reference to FIGS. 2 through 5.

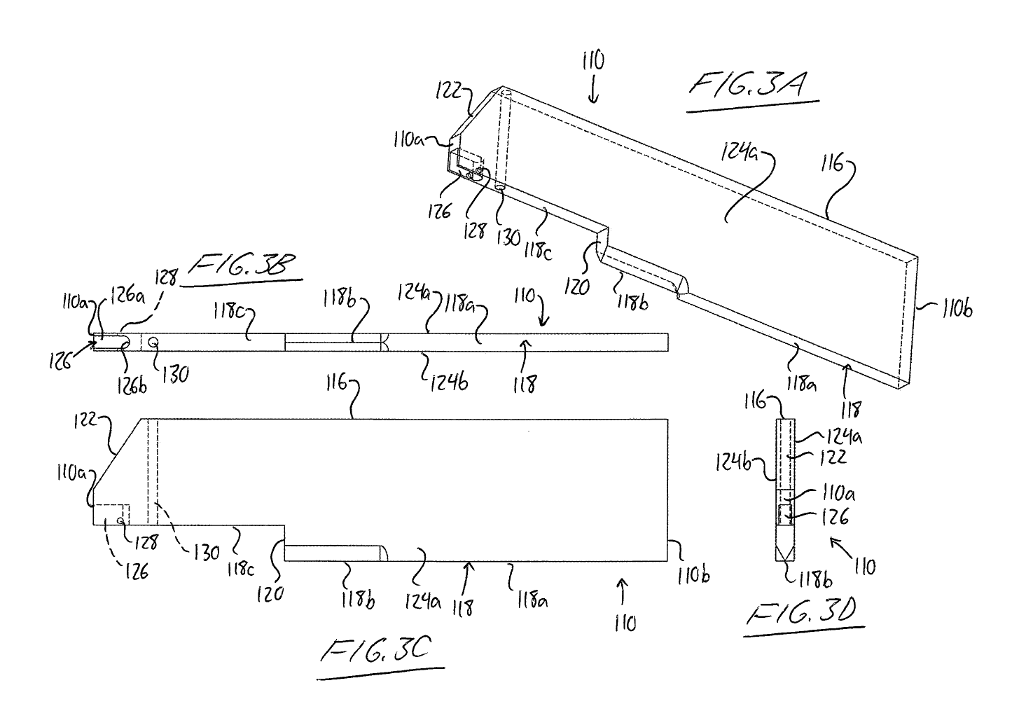

FIG. 3 shows the tool holder body 110 in isolation. The parallel longitudinal edges 116, 118 of the tool holder body 110 that ride along the guide walls 106a, 106b are perpendicularly joined by the straight second end 110b of the tool body. The longitudinal edge 116 that faces the direction of the tire's rotation is a flat edge from end to end. The longitudinal edge 118 that faces opposite the tire's rotation of direction features a flattened portion 118a extending from the second end 110b toward the first end 110a for approximately half of the tool holder body's overall length. From this intermediate point, the longitudinal edge then continues on with a sharpened portion 118b that spans approximately a third of the remaining half of the tool body's length. The sharpened point of this sharpened portion 118b of this longitudinal edge 118 lies in the same plane as the flattened portion 118a of this longitudinal edge 118. At the end of the sharpened edge portion 118b furthest from the flattened edge portion 118a, a right-angle shoulder 120 juts inwardly of the tool body 110 and joins the sharpened edge portion 118b to a flat remainder 118c of this longitudinal edge that joins up with the first end 110a of the tool body and is offset inwardly from the flattened and sharpened portions 118a, 188b of this longitudinal edge.

The first end 110a of the tool holder body 110 lies parallel to the second end 110b, and thus extends perpendicularly from the offset portion 118c of the longitudinal edge 118 that faces opposite the tire's direction of rotation. A bevel edge 122 obliquely joins the first end 110a to the fully flat longitudinal edge 116 that spans nearly the full length of the tool body. Being plate shaped, the tool, body features two parallel, flat side faces 124a, 124b that are joined together by the perimeter edges. These faces respectively define the flat top and bottom sides or faces of the tool body 108 when installed in the illustrated tire cutting apparatus 10.

A generally rectangular socket 126 extends into the tool holder body 110 at the corner formed between the front edge 110a and the offset portion 118c of the longitudinal edge 118. The socket is open at both these edges 110a, 118c, and closed at both of the side faces 124a, 124b of the tool holder body 108. A flat, closed side 126a of the socket lies parallel to and opposite the open side of the socket at the offset portion 118c of the longitudinal edge 118. As shown, a closed inner end 126b of the socket that lies opposite the front edge 110a of the tool holder body 110 may be curved in a manner facing concavely toward the open end of the socket at the front edge thereof. A transverse bore 128 passes perpendicularly through the side faces 124a, 124b of the tool holder body and spans the thickness dimension of the plate-shaped body at a position crossing through the socket 126 near the inner end 126b thereof and near the open side of the socket at the offset longitudinal edge portion 118c of the tool holder body. A fastener bore 130 passes through the tool holder body 110 at the longitudinal edges 116, 118 in a direction perpendicular to the parallel planes of these edges at a location near the corner that is defined between the bevel edge 122 and the fully-flat longitudinal edge 116 and shortly past the closed inner end 126b of the socket.

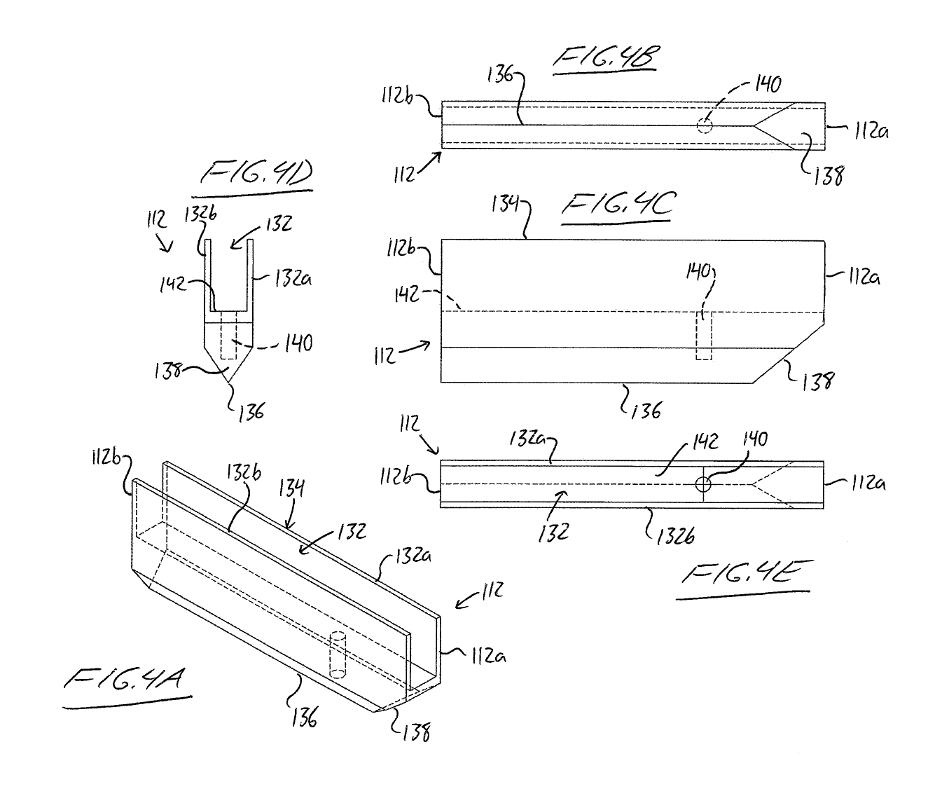

FIG. 4 shows the cutting edge member 112 in isolation, while FIG. 2 shows it installed on the tool holder body 110. The cutting edge member 112 may be formed from a plate of greater hardness than the tool holder body, for example ½-inch A2 steel plate of elongated shape, the longitudinal dimension of which lies parallel to that of the tool holder body 110 when the pieces are assembled together.

With reference to FIG. 4, a rectangular channel 132 runs longitudinally through the cutting edge member 112 from a first end 112a thereof to an opposing second end 112b thereof, for example spanning approximately one half of the width dimension that lies perpendicular of the longitudinal or lengthwise dimension. The width of the channel (measured in the thickness direction of the plate) is such that the resulting side walls 132a, 132b of the channel can be slid over the respective side faces 124a, 124 of the tool holder body 110 at the offset portion 118c of the longitudinal edge 118 thereof so as to the fit the cutting edge member 112 onto the longitudinal edge 118 of the tool holder body adjacent the front end 110a thereof. The channel may be dimensioned with a width slightly smaller than the tool holder thickness in order to provide a snug interference fit therewith.

Opposite a longitudinal edge 134 of the cutting edge member 112 at which the rectangular channel 132 is open, a parallel longitudinal edge 136 is sharpened to form a cutting edge of the tool assembly. The ends 112a, 112b of the cutting edge member 112 are parallel with one another and perpendicular to the two longitudinal edges 134, 136, and a bevel edge 138 obliquely connects the front front end 112a, which is the shorter of the two ends, with the sharpened edge 136, which is the shorter of the two longitudinal edges. A threaded blind hole 140 extends into the cutting edge member at the bottom 142 of the rectangular channel 132 (i.e. at the flat side of the rectangular channel lying opposite the open side of the channel at the longer longitudinal edge 134).

Turning back to FIG. 2, the length of the cutting edge member 112 matches the length of the offset longitudinal edge portion 118c of the tool holder body 110, and the angle of the sharpened edge 136 of the cutting edge member 112 matches that of the sharpened edge portion 118b of the tool holder body 110. The cutting edge member is slid onto the tool holder body 110 into a position abutting the flat second end 112b of the cutting edge member 112 up against the flat shoulder 120 of the tool holder body 110, whereby the open first end 112a of the of the cutting edge member 112 resides flush with the front end 110a of the tool holder body 110. The depth of the rectangular channel 132 of the cutting edge member from the open side thereof at longitudinal edge 134 to the bottom 142 of the channel matches the span of the tool body shoulder 120 from the offset edge portion 118c to the sharpened edge portion 118c, whereby the sharpened edge 136 of the cutting edge member aligns with the sharpened edge portion 118c of the tool holder body to form a continuous extension thereof. The bevel edge 138 of the cutting edge member obliquely transitions from the sharpened edge 136 of the edge member 112 to the flushly situated front ends 112a, 110a of the edge member and tool holder body.

With the cutting edge member 112 in this seated position on the tool holder body 110, the edge member's blind hole 140 aligns with the fastener hole 130 of the tool holder body 110. To secure the cutting edge member 112 to the tool holder body 110, a threaded fastener 144 is fed through the fastener bore 130 to matingly engage the free end of its threaded shaft with the threaded blind hole 140. Tightening of the fastener via a hex-head 144a or other drivable head of the fastener at the longitudinal edge 116 of the tool body acts to clamp the bottom 142 of the edge member's rectangular channel 132 tightly against the offset longitudinal edge portion 118c of the tool holder body 110. The head diameter of the fastener is less than the thickness of the plate-shaped tool holder body 100 so as not to project beyond the side faces 124a, 124b thereof.

The sharpened edges 118c, 136 of the tool holder body 110 and the cutting edge member 112 form a cutting edge of the tool for performing a circumferential ripping action on the tire T during the driven rotation thereof. The cutting edge member 112 is made of a harder material than the tool holder body and forms the substantial majority of the overall cutting edge, spanning from the front end 110a of the tool holder body back to the sharpened edge portion 118b thereof. The length of the cutting edge member may be selected to exceed the maximum crown-thickness of the expected tire sizes to be cut by the apparatus, whereby any exposure of the sharpened edge portion 118b of the tool body is minimized in order to maximize the life of the tool holder body 110 and make optimal use of the harder wear material of the removable and replaceable cutting edge member 112.

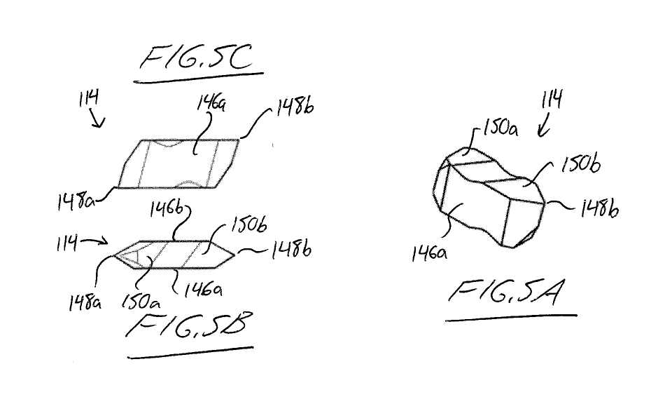

FIG. 5 shows the cutting tip member 114 of the cutting tool, which may be provided in the form of a commercially available insert, for example a carbide threading insert, for example such as Top Notch™ NT threading inserts available from Kennametal. Prototype cutting assemblies of the present invention employ a Kennametal K 68 NT4L threaded insert as a removable and replaceable, double-pointed tip member 114. With reference to FIG. 5, such a tip member features an elongated body with a somewhat parallelogram-like shape in side view. Each side features a flat central area 146a, 146b, from which the side slopes inwardly from both ends of this central area to form tapered ends of the body, which are sharpened at diagonally opposite extents of the two ends so as to form a pair of diagonally opposite sharpened points 148a, 148b.

The thickness of the tip member 114, measured between the flat, parallel side surfaces 146a, 146b is approximately equal to, or slightly less than, the width of the socket 126 of the tool holder body (as measured in the thickness direction of the tool holder's plate-like shape), while the length of the tip member exceeds that of the socket (as measured from the tool body's first end 110a to the opposing closed end 126b of the socket). The depth of the socket, measured from the offset edge portion 118c to the opposing closed side 126a of the socket 126, equals the width of the tip member 114. Each one of two longitudinal edges of the tip member 114 spans from one end of the tip member to the other (i.e. from the pointed extent of one end to the non-pointed extent of the other end) and has two coplanar surfaces 150a, 150b that lie parallel to matching but reversed coplanar surfaces of the opposing longitudinal edge.

Prior to installation of the cutting edge member, insertion of the tip member in the socket in a manner placing these coplanar surfaces 150a, 150b of one edge of the tip member against the flat closed side 126a of the socket acts to place the coplanar surfaces of the other longitudinal edge of the tip member 114 flush with the offset edge 118c of the tool holder body 110, whereby subsequent installation of the cutting edge member 112 will clamp the bottom 142 of the rectangular channel 132 of the cutting edge member up against the flat surface 150a, 150b of the exposed longitudinal edge of the cutting tip member 114 at the offset edge portion 118c of the tool holder body. This clamps the flat surface 150a , 150b of the other longitudinal edge of the tip member 114 against the closed side 126a of the socket in order to secure the tip member within the socket. In addition, where an interference fit between the cutting edge member and tool holder body is employed, the installation of the cutting edge member will also clamp the faces 124a, 124b of the tool holder body against the flat side faces 146a, 146b of the tip member 114 in order to further secure the tip member in place in the socket 126.

During manufacture of the tool holder body, a roll pin 152 is installed in the transverse bore 128 of the tool holder body to as to extend across the socket 126 near the closed inner end 126b thereof. The roll pin is short enough so as to not to project outwardly beyond the faces 124a, 124b of the tool holder body 110 when installed, thereby not interfering with subsequent installation of the cutting edge member 112. As the length of the tip member 114 exceeds that of the socket 126, insertion of the tip member into the socket leaves one of the pointed ends 158a, 148b of the tip member 114 outside the socket 126, so that the tip member 114 projects beyond the first end 110a of the tool holder body 110 in order to point toward the central axis A of the cutting apparatus 10 so as to form a tire-piercing tip that is driven into the crown C of the tire T under extension of the cutting assembly's hydraulic cylinder 102. As best shown in FIG. 2C, the exposed point 148a of the tip member 114 outside the socket 126 should be situated in-plane with the open side of the socket 126 at the offset edge portion 118c. As a result, the other point 148b of the tip member inside the socket 126 points toward the interior corner of the socket, as defined at the intersection of the closed side 126a of the socket and the closed inner end 126b thereof.

The roll pin 150 is situated distal near where the closed inner end 126b of the socket 126 intersects the offset edge portion 118c of the tool holder body, but far enough from the closed socket end 126b so that a flat bevel surface or end face 154 of this interior end of the inserted tip member 114 will abut against the roll pin 152 before the sharpened point 148b of the tip member 114 can reach the closed end 126b of the socket 126. This way, when a replaceable tip member is first installed and used, the inserted point 148b of the tip member 114 does not contact the closed end of the socket, even when exposed to reaction forces from the tire under extension of the cutting assembly cylinder 102. When the exposed point 148a of the tip member 114 has become significantly worn or dulled, the cutting edge member 112 can be removed to access the tip member 114, which can then be withdrawn from the socket 126 and rotated through 180-degrees about an axis perpendicular to its side faces, and reinserted in the socket in this reversed orientation in order to now use the still-sharp second point 148b as the tire-piercing point. This effectively doubles the wear life of the tip member versus a single-pointed replaceable tip member.

The detailed embodiment is able to cut through the varied combination of materials (e.g. rubber and steel) used in Off the Road and Giant Mining Tires, where the steel of the tool bit holder 110 can stand up to the stress of the work while the replaceable tip or bit member 114 employs harder carbide that to make up the leading edge of the assembled cutting unit. In other words, the less brittle material of the tool holder withstands the stresses imposed on the assembly during cutting the steel and rubber composition of the tire, while the harder materials of the replaceable cutting members provide better wear resistance at the cutting areas.

In summary, the tip or bit supporting unit of the illustrated embodiment is composed of three pieces, namely the tool holder, the hardened edge-defining wear component, and one screw that holds all the pieces in place. All of this is designed to securely and accurately place and hold the appropriate carbide bit in place allowing it to be eased into the material as the giant mining tire turns on the turntable. All of this is designed to securely and accurately place and hold the appropriate carbide bit in place allowing it to eased into the material as the giant mining tire turns on the turntable.

Although designed to address shortcomings in prior art processing of Off the Road and Giant Mining Tires, it will be appreciated that a similar cutting assembly may be used in processing of other classes of tire as well.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A tire cutting apparatus for cutting tires into sections, the apparatus comprising:
a rotational support device arranged to receive and carry a tire in a mounted position carried on the rotational support device, and to effect driven rotation of the tire in the mounted position about a rotational axis passing centrally through a central opening of the tire around which the tire circumferentially closes;
a cutting tool assembly comprising:
a tool holder movably supported at a location radially spaced from a circular path around the rotational axis at which the crown of the tire resides in the mounted position, the tool holder having a first end disposed radially nearer the circular path than an opposing second end; and
one or more cutting members removably installed on the tool holder to each form a respective cutting feature thereon proximate the first end of the tool holder, each of said one or more cutting members comprising a wear material of greater hardness than the tool holder;
and an actuator operable to force the tool holder from a non-cutting state, in which the cutting tool assembly does not reach the circular path, into a cutting state in which the cutting tool assembly reaches said circular path so as to cut into the crown of the tire.

2. The apparatus of claim 1 wherein the one or more cutting members comprise a tip member and the tool holder is arranged for removable mounting of the tip member at the first end of the tool holder in a cutting position projecting from the first end of the tool holder with a point of the tip member pointing away from the tool holder.

3. The apparatus of claim 2 wherein the tip member is double pointed, having a pair of opposing points situated at opposing ends of the tip member and pointing in opposite directions therefrom.

4. The apparatus of claim 2 wherein the tool holder comprises a hollow mounting socket extending into the tool holder from the first end thereof for installation of the tip member into the cutting position by insertion of the tip member into a position partially seated within the mounting socket.

5. The apparatus of claim 3 wherein the tool holder comprises:
a hollow mounting socket extending into the tool holder from the first end thereof for installation of the tip member into the cutting position by insertion of the tip member into a position partially seated within the mounting socket; and
a blocking member spanning across the mounting socket at a distance from an inner end thereof to block abutment of either point of the tip member with the inner end of the mounting socket under insertion of said point of the tip member into the mounting socket.

6. The apparatus of claim 5 wherein the blocking member comprises a roll pin inserted into a transverse bore of the through body that passes through the mounting socket.

7. The apparatus of claim 1 wherein the one or more cutting members comprise an edge member arranged to fit over an edge of the tool body that faces opposite a direction of the tire's rotation so as to provide said edge of the tool body with a cutting edge that splits the crown of the tire apart around the circumference thereof as the tire rotates past the tool body after initial piercing of the tip member into the crown of the tire.

8. The apparatus of claim 1 wherein the one or more cutting member comprise an edge member arranged to fit over an edge of the tool body that faces opposite a direction in which the tire is rotated by the rotational support device so as to provide said edge of the tool body with a cutting edge that splits the crown of the tire apart around the circumference thereof as the tire rotates past the tool body after initial piercing of the tip member into the crown, the edge member also being arranged to secure the tip member in place in the cutting position.

9. The apparatus of claim 8 wherein the edge member fits over an open side of the socket at the edge of the tool body that faces opposite the direction in which the tire is rotated by the rotational support device.

10. The apparatus of claim 9 wherein the tip member, the socket and the edge member are cooperably sized and shaped so as to place the edge member in clamping abutment with the tip member to secure the tip member in place in the socket.

11. The apparatus of claim 9 wherein the socket and the tip member are cooperably sized and shaped to place a surface the tip member flush with the open side of the socket, and the edge member clamps against said surface of the tip member at said open side of the socket to clamp the tip member against an opposing closed side of the socket.

12. The apparatus of any one of claim 7 comprising a fastener bore passing through the tool body from the edge of the tool body that receives the edge member to an opposing edge of the tool body to enable fastening of the edge member to the tool body via said fastener bore.

13. The apparatus of claim 7 wherein a sharpened portion of the edge of the tool body at which the edge member is received is left uncovered by said edge member adjacent an end of said edge member opposite the first end of the tool body.

14. The apparatus of claim 1 wherein the edge member is arranged to reach fully to the first end of the tool body, and comprises a sloped edge that slopes obliquely from the cutting edge to the first end of the tool body.

15. The apparatus of claim 1 wherein the tool body comprises an elongated plate-shaped member, the first and second ends of the tool body are spaced apart along a length dimension of said plate-shaped member and a width dimension of the plate-shaped member lies in a plane perpendicular to the rotational axis.

16. The apparatus of claim 15 wherein the plate-shaped member comprises metal plate.

17. The apparatus of claim 1 wherein the wear material of at least one of the one or more cutting members comprises tungsten carbide.

18. The apparatus of claim 1 wherein the location at which the tool holder is movably supported is disposed radially outward from the circular path such that the cutting tool assembly resides radially outward of the circular path in the non-cutting state and each cutting feature reaches the circular path under driving of the cutting assembly inwardly through the circular path by the actuator.

19. A cutting tool assembly for a tire cutting apparatus having a rotational support device arranged to support and rotate a tire about a rotational axis passing centrally through a central opening of the tire and an actuator operable to force the cutting tool into the crown of the tire so as to cut into and through the crown around the circumference of the tire during driven rotation of the tire by the rotational support device, the cutting tool comprising:
a tool holder; and
one or more cutting members removably installed on the tool holder to form at least one cutting feature thereon proximate a first end of the tool holder for cutting the tire by forcing of said first end of the tool holder toward the crown of the tire, each cutting member comprising a wear material of greater hardness than the tool holder.
